(19) United States
(12) Patent Application Publication
(10) Pub. No.: US 2010/0070087 A1
(43) Pub. Date: Mar. 18, 2010

(54) AIR CONDITIONING SYSTEM

(75) Inventors: Kiyoshi Shima, Osaka (JP); Hisashi Sumida, Osaka (JP)

Correspondence Address: BIRCH STEWART KOLASCH & BIRCH, PO BOX 747, FALLS CHURCH, VA, 22040-0747, US

(73) Assignee: DAIKIN INDUSTRIES LTD, OSAKA-OSAKA (JP)

(21) Appl. No.: 12/448,000

(22) PCT Filed: Nov. 26, 2007
(86) PCT No.: PCT/JP2007/072772

§ 371 Date: Apr. 30, 2009

(30) Foreign Application Priority Data
Nov. 28, 2006 (JP) 2006-120011

(51) Int. Cl. G05B 15/00

(52) U.S. Cl. 700/277

(57) ABSTRACT

A remote controller includes a display part and an operation part. Since the display part switches plural kinds of specifications to display behavior and setting conditions of an air conditioner, plural kinds of specifications are prepared in the display part. From a central controller a communication part receives a command for air conditioning behavior of an air conditioner and switching of the display specification. The command includes packet for storing information which indicates switching of the display specification. As a result, the central controller can centrally and individually control both the air conditioning behavior of the air conditioner and switching of the display specification in the display part without operating the display part for each of the air conditioners from a distance.

### TECHNICAL FIELD

The present invention relates to an air conditioning system comprising a plurality of air conditioners and a central controller which centrally and individually controls an air conditioning behavior thereof.

### BACKGROUND ART

When an air conditioner is equipped in each of rooms, there is a technique to provide a central controller for centrally and individually controlling an air conditioning behavior. The air conditioner is generally provided with a remote controller which includes a display part for displaying operation and working condition. For example, Patent document 1 introduces a technique performing communication among a remote controller, an indoor unit and an outdoor unit, and for example, Patent document 2 introduces display of a remote controller.

Patent document 1: Japanese Patent Application Laid-Open No. 2006-29687

Patent document 2: Japanese Patent Application Laid-Open No. 2001-311546

### DISCLOSURE OF INVENTION

### Problems to be Solved by the Invention

In a room like a hotel room where a user changes every day there is a request to change a language and character size of a remote controller in accordance with a user who stays in the room on that day. However, it is troublesome to perform an operation for such a change in each room.

The present invention has been made in view of the above circumstances, and has an object to centrally change display specification remotely without operating a display part for each of air conditioners.

### Means for Solving the Problems

A first aspect of an air conditioning system according to this invention comprises a plurality of air conditioners (21, 22, 23) each having a display part (41) for switching plural kinds of specifications to display and a central controller (10) for centrally controlling switching of the individual specification for each of the air conditioners.

It is preferable for the central controller (10) to centrally control switching of individual air conditioning behavior for each of the air conditioners.

A second aspect of the air conditioning system according to this invention is the first aspect of the air conditioning system, in which the central controller (10) centralizes and controls switching of the individual air conditioning behavior for each of the air conditioners. Each of the air conditioners (21, 22, 23) includes an indoor unit (3) for performing the air conditioning behavior. The central controller (10) provides a command (S) for instructing the air conditioning behavior and switching of the specifications to said indoor unit, in which a part for instructing to switch the specifications is extracted from the command and provided to the display part (41), and then the display part switches the specifications to display based on the part.

It is preferable for each of the air conditioners (21, 22, 23) to include a remote controller (4) which comprises the display unit (41).

A third aspect of the air conditioning system according to this invention is the first and second aspects of the air conditioning system, in which a language used for display of the display unit (41) is changed by switching of the specifications.

A forth aspect of the air conditioning system according to this invention is the first to third aspects of the air conditioning system, in which size of character used for display of the display unit (41) is changed by switching of the specifications.

A fifth aspect of the air conditioning system is the first to forth aspects of the air conditioning system, in which a unit of temperature used for display of the display unit (41) is changed between Celsius and Fahrenheit by switching of the specifications.

### Effects of the Invention

According to the first aspect of the air conditioning system of this invention, a display specification is centrally changed without operating the display part for each of air conditioners from a distance. In a room like a hotel room where a user changes every day, for example, it is preferable when changing a language and size of character in accordance with a user who stays in the room on that day.

According to the second aspect of the air conditioning system of this invention, the command for switching of the specifications can be provided to the air conditioner from the central controller, which is accompanied by the command for instructing the air conditioning behavior without being prepared separately.

According to the third aspect of the air conditioning system of this invention, the central controller can centrally and individually control display with a language which is easily understandable for a user.

According to the forth aspect of the air conditioning system of this invention, the central controller can centrally and individually control display with size which is easily viewable for a user.

According to the fifth aspect of the air conditioning system of this invention, the central controller can centrally and individually control display with a temperature system which is easily understandable for a user.

These and other objects, features, aspects and advantages of the present invention will become more apparent from the following detailed description of the present invention when taken in conjunction with the accompanying drawings.

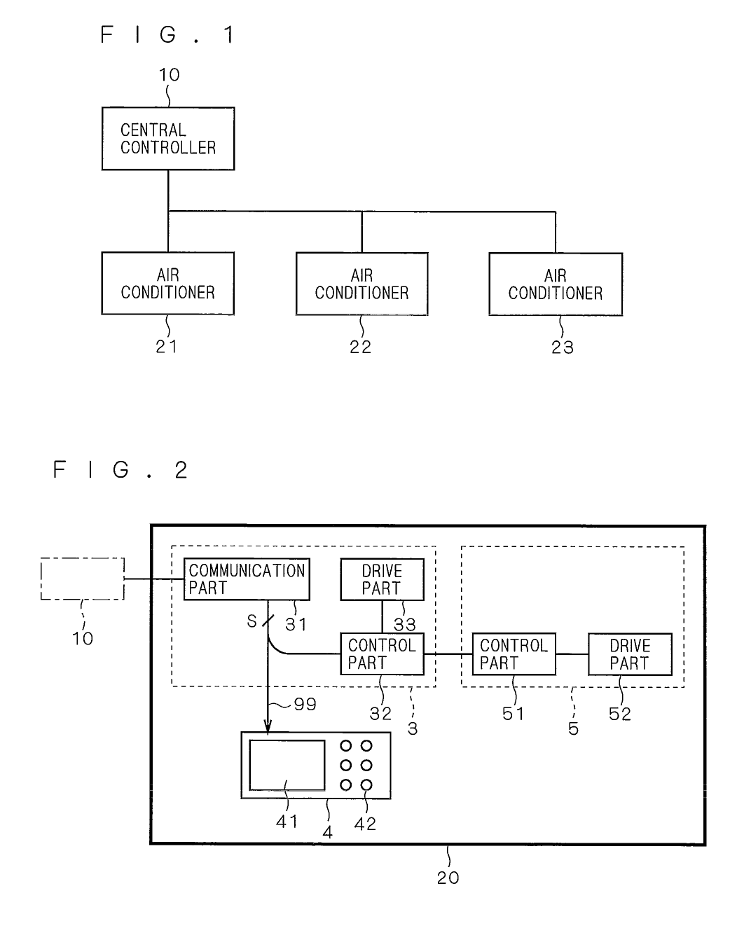

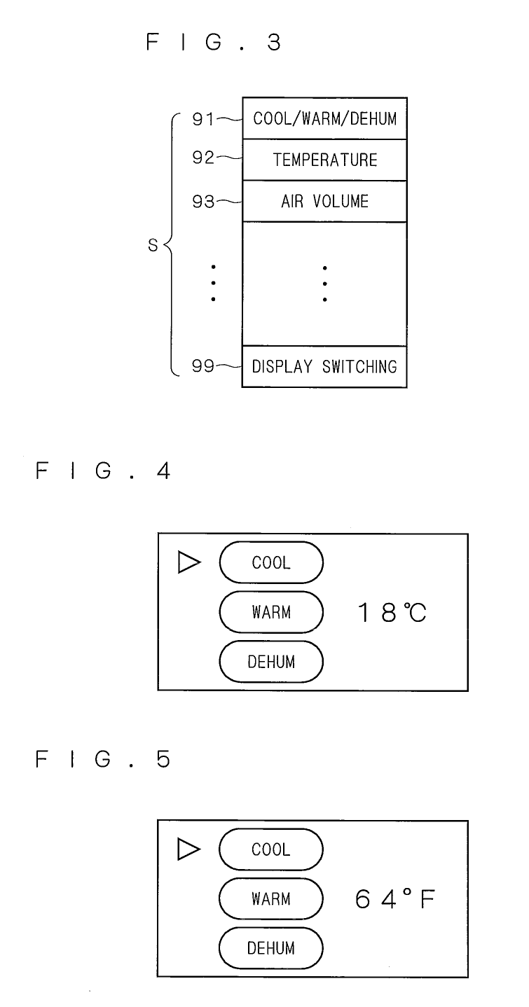

### BRIEF DESCRIPTION OF DRAWINGS

[FIG. 1] a block diagram illustrating the configuration of an air conditioning system according to this invention.

[FIG. 2] a block diagram illustrating the configuration adopted by an air conditioner.

[FIG. 3] a schematic diagram illustrating the configuration of a command from a central controller.

[FIG. 4] a schematic diagram illustrating switching of a display specification in a display part.

[FIG. 5] a schematic diagram illustrating switching of a display specification in a display part.

### BEST MODE FOR CARRYING OUT THE INVENTION

FIG. 1 is a block diagram illustrating the configuration of an air conditioning system according to this invention. The air conditioning system comprises a plurality of air conditioners 21, 22, and 23, and a central controller 10 which centrally and individually controls air conditioning behavior thereof.

FIG. 2 is a block diagram illustrating a configuration 20 adopted by all of the air conditioners 21, 22 and 23. The air conditioners comprise an indoor unit 3, a remote controller 4 and an outdoor unit 5. The indoor unit 3 includes the central controller 10, a communication part 31 for performing communication with the central controller 10, a control part 32 for controlling an air conditioning behavior and a drive part 33 for performing the air conditioning behavior. The outdoor unit 5 includes a control part 51 for controlling the air conditioning behavior and a drive part 52 for performing the air conditioning behavior. The control parts 32 and 51 are connected to each other operating in harmony, and thereby, the drive parts 33 and 52 also operate in harmony. For example, the drive part 33 includes a heat exchanger and a fan, and the drive part 52 includes a refrigerant compressor and a heat exchanger.

The remote controller 4 includes a display part 41 and an operation part 42. A user sets the air conditioning behavior by using the operation part 42. Note that illustration and description on a control of the control part 32 by the operation part 42 are omitted here to avoid complication.

Since the display part 41 switches plural kinds of specifications to display behavior and setting conditions of the air conditioner, plural kinds of specifications are prepared in the display part 41. The display part 41 which includes such plural kinds of specifications can be easily realized, for example, by adopting a liquid crystal display with a segment display style. As a display of the display part 41, difference among cooling, warming, dehumidification and a preset temperature can be illustrated.

The communication part 31 receives a command S from the central controller 10, the command S performing an air conditioning behavior and switching of a display specification. FIG. 3 is a schematic diagram illustrating the configuration of the command S in which packets 91 to 99 are employed as parts making up the command S.

A packet 99 stores information which indicates switching of the display specification, and packets other than the packet 99 store information for performing the air conditioning behavior. For instance, a packet 91 stores a setting of cooling, warming and dehumidification, a packet 92 stores preset temperature, and a packet 93 stores preset air volume, respectively. Other packets which are not shown store information for performing the air conditioning behavior, or store nothing.

As described above, since the command S received from the central controller 10 includes the packet 99 for storing information which indicates switching of the display specification, the central controller 10 can centrally and individually control both the air conditioning behavior of the air conditioners 21, 22 and 23 and switching of the display specification in the display part 41 without operating the display part 41 for each of the air conditioners from a distance.

Specifically, because the packet 99 is extracted from the command S in the indoor unit 3 and provided to the display part 41, the command for switching of the display specification can be provided to the air conditioners 21, 22 and 23 from the central controller 10, which is accompanied by the command for instructing the air conditioning behavior without being prepared separately.

FIGS. 4 and 5 are schematic diagrams illustrating switching of the display specification in the display part 41. FIG. 4 is a display of Japanese and Celsius, while FIG. 5 is a display of English and Fahrenheit. Switching to display with a language and a temperature system which are easily understandable for a user like this can be centrally and individually controlled with the central controller 10 for a plurality of the air conditioners 21, 22 and 23 by using the packet 99 included in the command S.

Other than the display switching like the above, size of character used for the display of the display part 41 may be switched. As a result, switching to a display with character size which is easily viewable for a user can be centrally and individually controlled with the central controller 10 for a plurality of the air conditioners 21, 22 and 23 by using the packet 99 included in the command S.

While the invention has been shown and described in detail, the foregoing description is in all aspects illustrative and not restrictive. It is therefore understood that numerous modifications and variations can be devised without departing from the scope of the invention.

1-7. (canceled)

8. An air conditioning system, comprising:
a plurality of air conditioners each having a display part for switching plural kinds of specifications to display; and
a central controller for centrally controlling switching of individual of said specifications for each of said air conditioners.

9. The air conditioning system according to claim 8, wherein
said central controller centrally controls switching of individual air conditioning behavior for each of said air conditioners.

10. The air conditioning system according to claim 9, wherein
each of said air conditioners includes an indoor unit for performing said air conditioning behavior,
said central controller provides a command for instructing said air conditioning behavior and switching of said specifications to said indoor unit,
in said indoor unit a part for instructing to switch said specifications is extracted from said command and provided to said display unit, and
said display unit switches said specifications to display based on said part.

11. The air conditioning system according to claim 10, wherein
each of said air conditioners includes a remote controller, and
said remote controller comprises said display unit.

12. The air conditioning system according to claim 8, wherein
a language used for display of said display unit is changed by switching of said specifications.

13. The air conditioning system according to claim 9, wherein
a language used for display of said display unit is changed by switching of said specifications.

14. The air conditioning system according to claim 10, wherein
a language used for display of said display unit is changed by switching of said specifications.

15. The air conditioning system according to claim 11, wherein
a language used for display of said display unit is changed by switching of said specifications.

16. The air conditioning system according to claim 8, wherein
size of character used for display of said display unit is changed by switching of said specifications.

17. The air conditioning system according to claim 9, wherein
size of character used for display of said display unit is changed by switching of said specifications.

18. The air conditioning system according to claim 10, wherein
size of character used for display of said display unit is changed by switching of said specifications.

19. The air conditioning system according to claim 11, wherein
size of character used for display of said display unit is changed by switching of said specifications.

20. The air conditioning system according to claim 8, wherein
a unit of temperature used for display of said display unit is changed between Celsius and Fahrenheit by switching of said specifications.

21. The air conditioning system according to claim 9, wherein
a unit of temperature used for display of said display unit is changed between Celsius and Fahrenheit by switching of said specifications.

22. The air conditioning system according to claim 10, wherein
a unit of temperature used for display of said display unit is changed between Celsius and Fahrenheit by switching of said specifications.

23. The air conditioning system according to claim 11, wherein
a unit of temperature used for display of said display unit is changed between Celsius and Fahrenheit by switching of said specifications.
